(19) United States
(12) Patent Application Publication
(10) Pub. No.: US 2013/0013687 A1
(43) Pub. Date: Jan. 10, 2013

(54) Information Sharing Method and Mobile Device Thereof

(76) Inventor: Te-Chuan Liu, Taoyuan County (TW)

(21) Appl. No.: 13/539,494

(22) Filed: Jul. 2, 2012

Related U.S. Application Data
(60) Provisional application No. 61/504,317, filed on Jul. 5, 2011.

(51) Int. Cl. G06F 15/16

(52) U.S. Cl. 709/204

(57) ABSTRACT

An information sharing method for a mobile device is disclosed. The information sharing method includes registering an event in the mobile device; determining whether a software activity occurs during the event; marking information of a specific software activity with a tag corresponding to the event if the specific software activity occurs during the event; and sharing the information of the specific software activity with the tag.

### CROSS REFERENCE TO RELATED APPLICATIONS

This application claims the benefit of U.S. Provisional Application No. 61/504,317, filed on Jul. 5, 2011 and entitled “Wireless Service Providing Method”, the contents of which are incorporated herein by reference.

### BACKGROUND OF THE INVENTION

1. Field of the Invention

The present invention relates to an information sharing method and mobile device thereof, and more particularly, to an information sharing method and mobile device thereof capable of determining a specific software activity occurs during an event, and then automatically sharing information associated with the specific software activity according to an instruction of a user for convenience.

2. Description of the Prior Art

People like to share photos, but sharing digital photos through the Web can often be complicated and involve interesting variations. In a typical scenario, digital photos are uploaded to or downloaded from a Web site server by a user. The digital photos are integrated into the Web site and made available for browsing/downloading through the Web site server. These Web sites offer different degrees of security and control over who may add, delete, view and access the digital photos. Further, the user can configure the presentation of the digital photos such as by enhancing with, for example, captions or decorative backgrounds, laying out and categorizing the digital photos.

However, other than simply e-mailing, or instant messaging digital photos/videos or links to digital photos/videos on a Web site to respective recipients or to one or more groups of recipients, there have not been many new and different sharing schemes for digital photos/videos. Indeed, past sharing schemes are time consuming and awkward when a user manually selects and shares large collections of digital photos/videos.

For example, when people start an event on a facebook website, it is inconvenient for people to share information of a software activity, such as photos or notes, during the event. Thus, there is a need to improve over the prior art.

### SUMMARY OF THE INVENTION

It is therefore an objective of the present invention to provide an information sharing method and mobile device thereof capable of determining a specific software activity occurs during an event, and then automatically sharing information associated with the specific software activity according to an instruction of a user for convenience.

The present invention discloses an information sharing method for a mobile device is disclosed. The information sharing method includes registering an event in the mobile device; determining whether a software activity occurs during the event; marking information of a specific software activity with a tag corresponding to the event if the specific software activity occurs during the event; and sharing the information of the specific software activity with the tag.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a mobile device.

FIG. 2 is a flow chart of an information sharing process according to an embodiment of the present invention.

FIG. 3 is a flow chart of an information sharing process according to another embodiment of the present invention.

### DETAILED DESCRIPTION

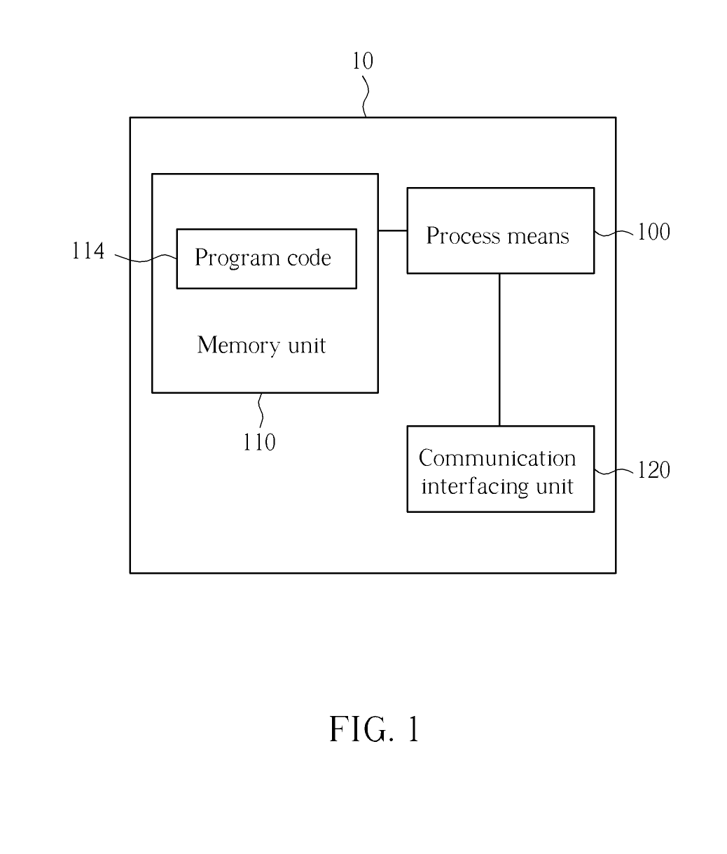

Please refer to FIG. 1. FIG. 1 is a schematic diagram of a mobile device 10. The mobile device 10 may include a processing means 100 such as a microprocessor or ASIC, a memory unit 110, and a communication interfacing unit 120. The memory unit 110 may be any data storage device that can store program code 114 for access by the processing means 100. Examples of the memory unit 110 include but are not limited to a subscriber identity module (SIM), read-only memory (ROM), random-access memory (RAM), CD-ROMs, magnetic tapes, floppy disks, and optical data storage devices. The communication interfacing unit 120 is preferably a radio transceiver for wirelessly communicating with the cloud service server according to processing results of the processing means 100.

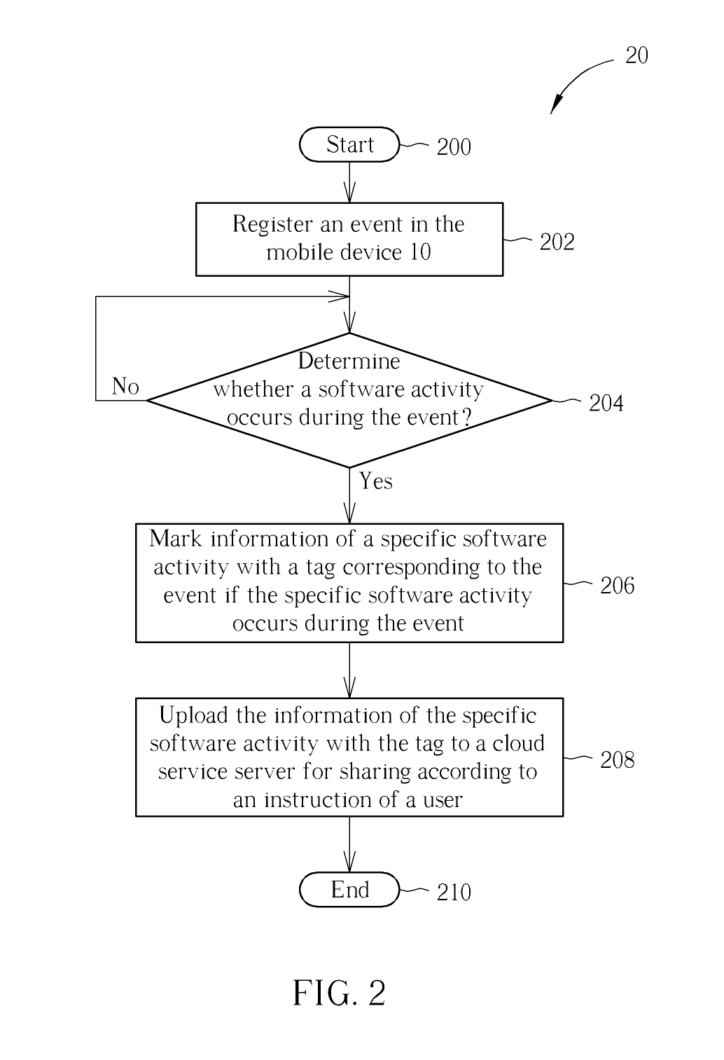

Please refer to FIG. 2, which is a flow chart of an information sharing process 20 according to an embodiment of the present invention. The information sharing process 20 is used for the mobile device 10. The information sharing process 20 can be compiled into the program code 114 and includes the following steps:

Step 200: Start.

Step 202: Register an event in the mobile device 10.

Step 204: Determine whether a software activity occurs during the event; if yes, go to step 208; otherwise; go to step 206.

Step 206: Mark information of a specific software activity with a tag corresponding to the event if the specific software activity occurs during the event.

Step 208: Upload the information of the specific software activity with the tag to a cloud service server for sharing according to an instruction of a user.

Step 210: End.

According to the information sharing process 20, a user can utilize the mobile device 10 to create an event and send notifications to other mobile devices of other participators, or to receive a notification of an event created by another device before or while an event starts, wherein an event can be a meeting event, a family activity event, a seminar event, etc. on a calendar. Then, the mobile device 10 registers an event by creating a new event, receiving an event or receiving a notification of event, and then storing a start time, an end time, event name, title, description and other related information of the event in the memory unit 110 of the mobile device 10. Therefore, the mobile device 10 can keep determining whether a software activity occurs during the event, e.g. taking photos, notes taking, document drawing, message making, information or status of the participators or location and any digital content generating. If a specific software activity occurs during the event, the mobile device 10 marks information of the specific software activity with a tag corresponding to the event, e.g. appending the tag which comprises the event name, the event start time, the event end time, the event title, the event description and any other information relating to the event to the information of specific software activity.

Afterwards, the mobile device 10 determines whether to share the information of the specific software activity according to an instruction of the user of the mobile device 10, e.g. the mobile device 10 may automatically ask the user whether to share the information of the specific software activity. In the case of the information sharing process 20, the mobile device 10 uploads the information of the specific software activity with the tag to a cloud service server for sharing according to the instruction of the user, and then the cloud service server automatically distributes the information of the specific software activity according to the tag, e.g. displaying, classifying, managing or storing the information of the specific software activity in a webpage or a server local storage related to the event which all participators of the event can access, such that all participators of the event can access the information of the specific software activity via the cloud service server.

Under such a situation, the mobile device 10 can automatically mark and upload the information of the specific software activity with the tag to the cloud service server, and then the cloud service server automatically distributes the information to the event to share with all participators of the event. As a result, the present invention provides a more convenient information sharing scheme since the user only has to decide whether the information of the specific software activity during the event should be shared.

For example, when a user joins an event on the Facebook website via the mobile device 10, e.g. a mobile phone, the mobile phone will get the registration data of the event. When the user makes software activities with the phone during the event, e.g. taking a photo, the phone will determine if the photo is taken during the event. If the photo is taken during the event, the phone will mark the photo to the event with a tag. Then, the phone can automatically ask the user whether to upload the photo to the cloud service server for sharing.

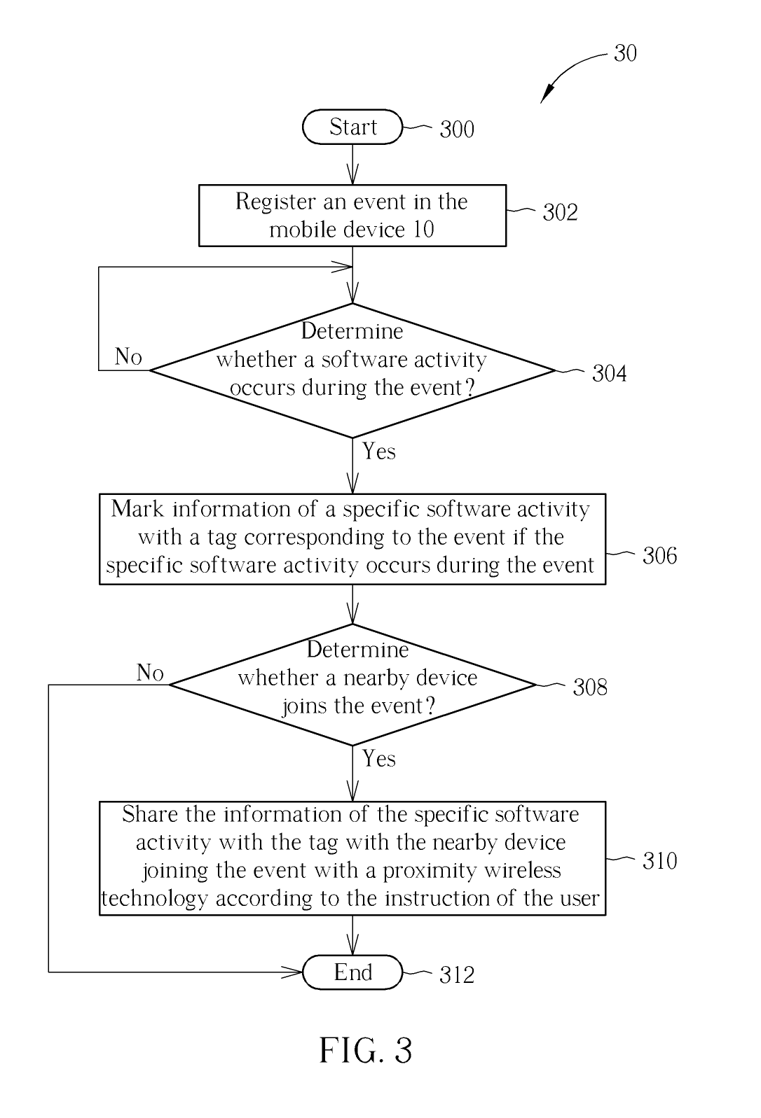

On the other hand, please refer to FIG. 3, which is a flowchart of an information sharing process 30 according to another embodiment of the present invention. The information sharing process 30 is used for the mobile device 10. The information sharing process 30 can be compiled into the program code 114 and includes the following steps:

Step 300: Start.

Step 302: Register an event in the mobile device 10.

Step 304: Determine whether a software activity occurs during the event; if yes, go to step 308; otherwise; go to step 306.

Step 306: Mark information of a specific software activity with a tag corresponding to the event if the specific software activity occurs during the event.

Step 308: Determine whether a nearby device joins the event; if yes, go to step 312; otherwise; go to step 314.

Step 310: Share the information of the specific software activity with the tag with the nearby device joining the event with a proximity wireless technology according to the instruction of the user.

Step 312: End.

The information sharing process 30 is similar to the information sharing process 20 (e.g. steps 300-306 are identical with steps 200-208), and thus partial operations of the information sharing process 30 can be derived by referring to the above description. The main difference between the information sharing process 30 and the information sharing process 20 is that the mobile device 10 uploads the information of the specific software activity with a tag to the cloud service server for sharing in the information sharing process 20, while the mobile device 10 directly shares the information of the specific software activity with a tag with a nearby device which joins the event in the information sharing process 30, wherein the nearby device can be a mobile device or a personal computer.

In detail, after the specific software activity occurs during the event and the mobile device 10 marks the information of the specific software activity with a tag during the event, the mobile device 10 can determine whether a nearby device joins the event. If a nearby device joins the event, the mobile device 10 can share the information of the specific software activity with the tag with the nearby device joining the event with a proximity wireless technology according to the instruction of the user.

The proximity wireless technology can be a proximity-based peer to peer (P2P) framework, e.g. AirLink, which allows mobile devices to establish direct connections with each other via Bluetooth, WiFi-Direct or other wireless transport layers. When the AirLink service is ON, the mobile device may advertise itself and discover nearby AirLink peers using a globally unique identification string (GUID). It is possible to associate the device GUID and the user information and craft a messaging system over the AirLink network that delivers messages to users based on their associated device GUIDs.

Under such a situation, the mobile device 10 can automatically mark and share the information of the specific software activity with the nearby device, and then the nearby device can automatically associate the information to the event. As a result, the present invention provides a more convenient information sharing scheme since the user only has to decide whether the information of the specific software activity during the event should be shared and the information of the specific software activity does not need to be shared with the nearby device of another participator via the cloud service server.

Noticeably, the spirit of the present invention is to automatically mark and share the information of the specific software activity when the specific software activity occurs during the event, so as to share the information of the specific software activity more conveniently. Those skilled in the art should make modifications or alterations accordingly. For example, the information sharing process 20 can be utilized for sharing the information of the specific software activity with remote and nearby devices which join the event via the cloud service server, and the information sharing process 30 can be utilized for directly sharing the information of the specific software activity with nearby devices which join the event more conveniently. In other embodiments, the information sharing process 30 can be combined with the information sharing process 20, such that the mobile device 10 can directly share the information of the specific software activity with nearby devices first, and then share the information of the specific software activity with remote mobile devices via the cloud service server.

Besides, the mobile device 10 can directly upload partial or all the information of the specific software activity when the specific software activity occurs without registering the event (i.e. the mobile device 10 does not need to create an event or receive an event and receiving a notification of an event created by another device for register) and marking the information with a tag corresponding to the event first. Under such a situation, when a cloud service server receives the information of the specific software activity from the mobile device 10, the cloud service server distributes the information of the specific software activity according to an event information of a user account of the mobile device 10 on the cloud service server rather than a tag corresponding to the event. The event information comprises an event name, an event start time, an event end time, an event title and an event description.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM). The mobile device 10 can be a mobile phone, a personal digital assistant (PDA), a lap top computer, a digital camera, a music player, a game device, or any other device with a processor, and the cloud service server can have structure similar to those of the mobile device 10 shown in FIG. 1 for performing the above related operations.

In the prior art, the user needs to manually select and share digital photos/videos or other information by uploading to a cloud server. In comparison, the present invention automatically share the information of the specific software activity when the specific software activity occurs during the event, so as to share the information of the specific software activity more conveniently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information sharing method for a mobile device, comprising:
registering an event in the mobile device;
determining whether a software activity occurs during the event;
marking information of a specific software activity with a tag corresponding to the event if the specific software activity occurs during the event; and
sharing the information of the specific software activity with the tag.

2. The information sharing method of claim 1, wherein the step of registering the event comprises one of the following steps:
creating the event, receiving the event and receiving a notification of the event created by another device.

3. The information sharing method of claim 1, wherein the step of registering the event comprises:
storing a start time and an end time of the event in the mobile device.

4. The information sharing method of claim 1 further comprising:
uploading the information of the specific software activity with the tag to a cloud service server for sharing.

5. The information sharing method of claim 1 further comprising:
determining whether a nearby device joins the same event.

6. The information sharing method of claim 1 further comprising:
sharing the information of the specific software activity with the tag to a nearby device joining the event with a proximity wireless technology.

7. The information sharing method of claim 1 further comprising:
sharing the information of the specific software activity with the tag according to an instruction of a user.

8. The information sharing method of claim 1, where the tag comprises at least one of the following information:
an event name, an event start time, an event end time, an event title and an event description.

9. An information sharing method for a server, comprising:
receiving information of a specific software activity with a tag corresponding to an event from a mobile device; and
distributing the information of the specific software activity according to the tag.

10. The information sharing method of claim 9, wherein the step of distributing the information of the specific software activity according to the tag comprises:
displaying, classifying, managing or storing the information of the specific software activity in a webpage or a server local storage related to the event.

11. The information sharing method of claim 9, wherein the mobile device registers the event in the mobile device and marks the information of the specific software activity with the tag corresponding to the event when the specific software activity occurs during the event before the mobile device uploads the information of the specific software activity with the tag to the server.

12. The information sharing method of claim 9, wherein the mobile device creates the event, receives the event or receives a notification of the event created by another device, and stores a start time and an end time of the event in the mobile device to register the event in the mobile device.

13. The information sharing method of claim 9, where the tag comprises at least one of the following information:
an event name, an event start time, an event end time, an event title and an event description.

14. An information sharing method for a server, comprising:
receiving information of a specific software activity from a mobile device; and
distributing the information of the specific software activity according to an event information of a user account of the mobile device on the server.

15. The information sharing method of claim 14, wherein the step of distributing the information of the specific software activity according to the event information of the user account of the mobile device on the server comprises:
displaying, classifying, managing or storing the information of the specific software activity in a webpage or a server local storage related to the event.

16. The information sharing method of claim 14, wherein the mobile device uploads the information of the specific software activity when the specific software activity occurs during the event.
